(19) United States
(12) Patent Application Publication
(10) Pub. No.: US 2009/0138287 A1
(43) Pub. Date: May 28, 2009

(54) System and method for assigning, recording and monitoring MS-DRG codes in a patient treatment facility

(76) Inventor: William J. Hermann, JR., Sealy, TX (US)

Correspondence Address: STRASBURGER & PRICE, LLP, 901 MAIN STREET, SUITE 4400, DALLAS, TX, 75202, US

(21) Appl. No.: 12/313,931

(22) Filed: Nov. 26, 2008

Related U.S. Application Data
(60) Provisional application No. 61/004,264, filed on Nov. 26, 2007.

(51) Int. Cl. G06Q 50/00; G06F 7/06; G06F 21/20; G06F 17/30; G06F 9/44; G06Q 10/00

(52) U.S. Cl. 705/3; 707/2; 726/11; 707/3; 707/9; 717/106; 707/E17.017

(57) ABSTRACT

A computer controlled system and method for assigning, recording and managing the additions to MS-DRG codes to patient administrative records in a patient treatment facility includes a coding information recording function and a coding communication tracking function. The coding information recording function both stores and facilitates communication between a patient administrative record coder and an attending physician to assure the timely assignment of an accurate attending physician approved MS-DRG code to a patient administrative record. The coding communication tracking function enables the coder, the attending physician and the management of the health care facility to monitor the status of communication between the coder and the attending physician regarding the assignment of an MS-DRG code to a patient administrative record.

### CROSS REFERENCE TO RELATED APPLICATION

This Non-Provisional U.S. Patent Application claims the priority of Provisional U.S. Patent Application 61/004,264 filed Nov. 26, 2007.

### STATEMENT REGARDING FEDERALLY FUNDED RESEARCH AND DEVELOPMENT

The invention described in this patent applicant was not the subject of Federally sponsored research or development.

### FIELD

The present invention pertains to a computer controlled information management system and method; more particularly, the present invention pertains to a computer controlled information management system and method for use in a patient treatment facility that uses Medical Severity-Diagnosis Related Group (“MS-DRG”) codes in patient administrative records.

### BACKGROUND

As shown in FIG. 1, at the time of patient intake to a patient treatment facility, two records are created. The first record is a patient treatment record. The patient treatment record contains medical information describing the patient as well as the injury, disease or malady which caused the patient to visit the patient treatment facility. Further the patient treatment record contains the impressions of the attending physician and other health care professionals regarding the diagnosis of the injury, disease or malady and the treatment provided to the patient by the patient treatment facility.

The second record, a patient administrative record is also created. The patient administrative record provides information that is primarily used to seek payment for the services provided to the patient by the patient treatment facility. It has become common in most patient treatment facilities for MS-DRG codes to be assigned to the identification of whatever injury, disease of malady that is diagnosed by an attending physician and for which the patient has received health care treatment at the patient treatment facility. These MS-DRG codes are entered into the patient administrative record by a coder who has access to the patient treatment record.

Payment for the health care treatment provided to the patient by the patient treatment facility may be provided in part by the patient and in part by one or more health care insurance companies. Most patient treatment facilities maintain computerized patient administrative records documenting the visit of a patient, the diagnosis of the injury, disease or malady and the treatment provided to the patient. Such computerized patient administrative records do not contain the impressions of the attending physician or other health care professionals. The MS-DRG codes in the patient administrative records are used, in part, to generate bills for health care services provided and to seek payment for health care services from health care insurance companies. In some situations the patient administrative record provided input to a permanent file which must be maintained by a patient treatment facility to meet regulatory or accreditation requirements.

Because of the extensive use of MS-DRG codes in patient treatment facilities to manage payment for the treatment of injuries, diseases or maladies, the prompt, efficient and accurate assignment of an MS-DRG code to a patient administrative record is essential to the successful operation of the business of recovering monies for the provision of health care services at a patient treatment facility. Any incomplete or delayed assignment of an MS-DRG code to a patient administrative record in a patient treatment facility has a direct effect on the ability of the patient treatment facility to collect monies for services rendered. Thus, the management of a patient treatment facility has a direct interest in assuring that MS-DRG codes are properly assigned to patient administrative records for all patients and that the MS-DRG codes are recorded in a timely manner in patient administrative records.

Many patient treatment facilities employ coders or retain professional coders at medical record coding services to begin the process of assigning an MS-DRG code to a patient administrative record. Thus, it is the task of a coder to a propose MS-DRG code number which appears to match a description of the diagnosed injury, disease or malady for which a patient has sought health care treatment at a patient treatment facility. While coders receive training in the assignment of MS-DRG codes to injuries, diseases, or maladies, it is not uncommon for a coder to have questions for the attending physician regarding the most accurate MS-DRG code or codes to describe a particular injury, disease or malady. Thus, coders often initiate requests for additional information from attending physicians to either supplement or clarify the information needed by the coder to initiate the MS-DRG code selection proposal process. The information provided by the attending physician in response to the request from the coder enables assigning an accurate MS-DRG code to a patient administrative record. Only a physician has the authority to assign an MS-DRG code to an injury, disease, or malady. Further, the information provided by the attending physician in response to a request from a coder assists in determining if either an “upcode” or “downcode” regarding the severity of the injury disease or malady is required. Once again, only physicians are authorized to “upcode” or “downcode” the MS-DRG code entry in a patient administrative record. Because of the physicians authority with regard to the final assignment of an MS-DRG code, any failure by attending physicians to provide coders with requested information or delays in providing coders with requested information will have a direct impact on the ability of the patient treatment facility to complete a patient administrative record and to promptly collect monies for health care services provided to patients.

The exchange of information between coders and attending physicians is often times a manual process—even in large hospitals with computerized record keeping systems. Because the exchange of information between a coder and an attending physician is typically an inefficient and error-prone manual process, it is not unusual for bottlenecks to occur in the flow of information, multiple requests for information being sent for a single patient, or coder requests for information from an attending physician being lost or disregarded.

Further, manual information exchange systems regarding the assignment of an MS-DRG code to a patient administrative record also exhibit the following problems:

difficulty of coders in establishing contact with attending physicians;

difficulty of attending physicians in accessing requests for information from coders when time is available for providing a response to a coder request for information;

inaccurate, or incomplete information provided to coders by attending physicians;

coder requests for information or attending physician responses to coder requests for information do not match continuing changes to the numbering or vocabulary updates made to the MS-DRG code system;

attending physicians have difficulty gaining access to requests from coders for information regarding the assignment of an MS-DRG code to a patient administrative record;

improper or inaccurate MS-DRG codes are assigned by coders to patient administrative records;

patient treatment facility management does not have a system to identify unanswered requests for information regarding assignment of an MS-DRG code to a patient administrative record or delayed responses to requests for information from coders to attending physicians regarding information regarding the assignment of an MS-DRG code to a patient administrative record.

Because a patient is not billed until an MS-DRG code is finalized in the patient administrative record a need remains in the art for a rapid computer controlled system and method for the assignment, management and recording of MS-DRG codes in a patient treatment facility.

Such rapid computer controlled system and method for the assignment, management and recording of MS-DRG codes to a patient administrative record in a patient treatment facility should provide the general features listed below:

notification to attending physicians that a coder request for additional information regarding the assignment of an MS-DRG code to a patient administrative record has been made;

notification to a coder that a response to a request for additional information regarding the assignment of an MS-DRG code to a patient administrative record has been provided by an attending physician;

consolidation of requests for information regarding the assignment of an MS-DRG code to a patient administrative record and responses to the coder requests from attending physician are stored in a single location;

standardization of the format for requests for information from coders regarding the assignment of an MS-DRG code to a patient administrative record and standardization of the responses from attending physicians to requests for information regarding the assignment of an MS-DRG code to a patient administrative record;

input to consolidated or permanent records retained voluntarily by a patient treatment facility or consolidated or permanent records required to be maintained by patient treatment facility regulatory bodies or accreditation agencies;

provision of management reports to identify break-downs or delays in the system of providing information in response to coders for information regarding the assignment of an MS-DRG code to a patient administrative record to include:
status (open, pending, completed) of individual requests for information from coders to physicians for information regarding the assignment of an MS-DRG code to a patient administrative record by patient/coder/physician;
outstanding and completed requests for information regarding the assignment of an MS-DRG code to a patient administrative record by patient/physician/coder;
delays between the initiation of requests by a coder for information regarding the assignment of an MS-DRG code to a patient administrative record and the response by the attending physician to the request by patient/physician/coder;

access to current information regarding MS-DRG code vocabulary and numbering schemes;

automatic notification when a request for information regarding the assignment of an MS-DRG code to a patient administrative record has not been answered by an attending physician in a predetermined period of time;

password control to prevent access to patient health care information by unauthorized personnel according to HIPAA requirements.

recording and controlling of requests for assistance from an attending physician to a consultant or a consulting physician when the attending physician needs information from a consultant or a consulting physician to provide a response to a coder for a request for information regarding the assignment of an MS-DRG code to a patient administrative record.

### SUMMARY

The disclosed computer controlled system and method for assigning, recording and managing MS-DRG code entries into a patient administrative record in a patient treatment facility provides the general features listed above in the BACKGROUND section.

More particularly, the computer controlled system and method for assigning, recording and managing MS-DRG code entries into a patient administrative record in a patient treatment facility provides the foregoing list of general features by use of a coding information recording function and a coding communication tracking function resident a software package operable by a computer.

The initiation of the process of entering an MS-DRG code into a patient administrative record begins with a coder. The coder creates that portion of a patient administrative record where MS-DRG codes are used to identify the injury, disease or malady for which a patient has received health care treatment at a patient treatment facility. To complete the portion of a patient administrative record with an assigned MS-DRG code, the coder must communicate with an attending physician to either gain additional information regarding the assignment of the proper MS-DRG code or to obtain the approval/disapproval of a proposed coder-assigned MS-DRG code. The system and method of the present invention both facilitates and tracks the communications between the coder and the attending physician as well as facilitating the selection and assignment of the physician-approved MS-DRG codes to be included in a patient administrative record.

Because the business of operating a patient treatment facility depends on the timely, accurate and complete completion of a patient administrative record with an MS-DRG code approved by an attending physician, the management of the patient treatment facility has a vested interest in the timeliness and completeness of the approval/disapproval by an attending physician of the MS-DRG code which appears in a patient administrative record. Accordingly, the system and method of the present invention uses both the coding information recording function and the coding communication tracking function to provide a variety of reports regarding the completion of patient administrative records by the assignment of an attending physician-approved MS-DRG code.

In certain situations it may be necessary for an attending physician to seek the assistance of a consultant or a consulting physician before the approval of an assigned MS-DRG code in a patient administrative record. When the attending physician seeks the assistance of a consultant or a consulting physician, the system and method of the present invention both facilitates and keeps track of the communication between the attending physician and the consultant or consulting physician. As with the communication between the coder and the attending physician, the system and method of the present invention provides reports on the status of any communication between an attending physician and a consultant or consulting physician.

### BRIEF DESCRIPTION OF THE DRAWING FIGURES

A still better understanding of the system and method for assigning, recording and managing the entry of a MS-DRG code into a patient administrative record in a patient treatment facility may be had by reference to the following drawing figures. The following drawing figures are further explained in the DESCRIPTION OF THE EMBODIMENTS section and the illustrative example.

FIG. 1 is a macro flow chart of a prior art system, as described in the BACKGROUND section, which shows the link between patient intake at a patient treatment facility, the creation of a patient treatment record, the creation of a patient administrative record and the billing for health care services provided to a patient by the patient treatment facility;

FIG. 2A is a macro overview of the coding information recording function of the system and method of the present invention;

FIG. 2B is a macro overview of the coding communication tracking function of the system and method of the present invention;

FIG. 3 is a screen that appears to a coder at the beginning the process of establishing that part of a patient administrative record which includes first proposing then assigning an attending physician-approved MS-DRG code;

FIG. 4 is a flow chart illustrating the initiation of a request from a coder for additional information from an attending physician to enable the insertion of an MS-DRG code to a patient administrative record and the tracking of the coder request for additional information to the attending physician;

FIG. 5 is a flow chart illustrating the response from the attending physician to the request from the coder for additional information regarding the assignment of an MS-DRG code and the tracking of the response from the attending physician to the coder request for additional information from the attending physician;

FIG. 6 is a flow chart illustrating the request by an attending physician for assistance from a consultant or a consulting physician to respond to a coder request for information regarding the assignment of an MS-DRG code into a patient administrative record and the tracking of the request by the attending physician to the consultant or the consulting physician and the response provided by the consultant or the consulting physician to the attending physician;

FIG. 7 is a flow chart illustrating the completion of the assignment of a physician-approved MS-DRG code to a patient administrative record by a coder to a patient record and the tracking of the completion of the MS-DRG code assignment process; and

FIG. 8 is a flow chart illustrating the handling of a question regarding an assigned MS-DRG code and the handling of a disapproval of an assigned MS-DRG code.

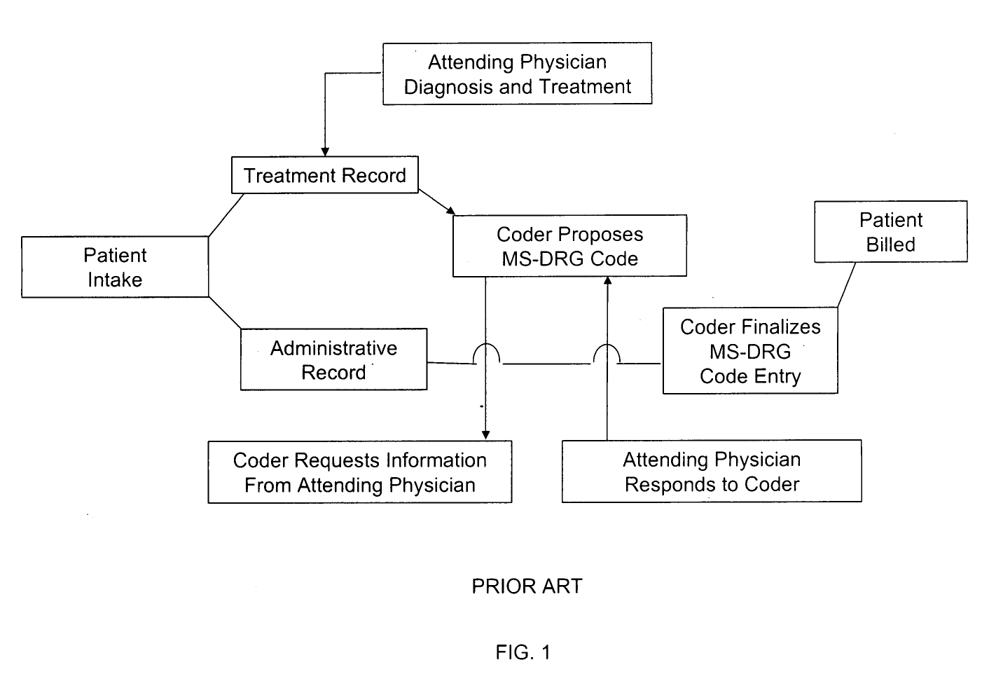

### DESCRIPTION OF THE EMBODIMENTS

A still better understanding of the system and method of the present invention may be had by general overview, an explanation of the various features provided, an illustrative operational example and a description of the reports enabled.

### General Overview

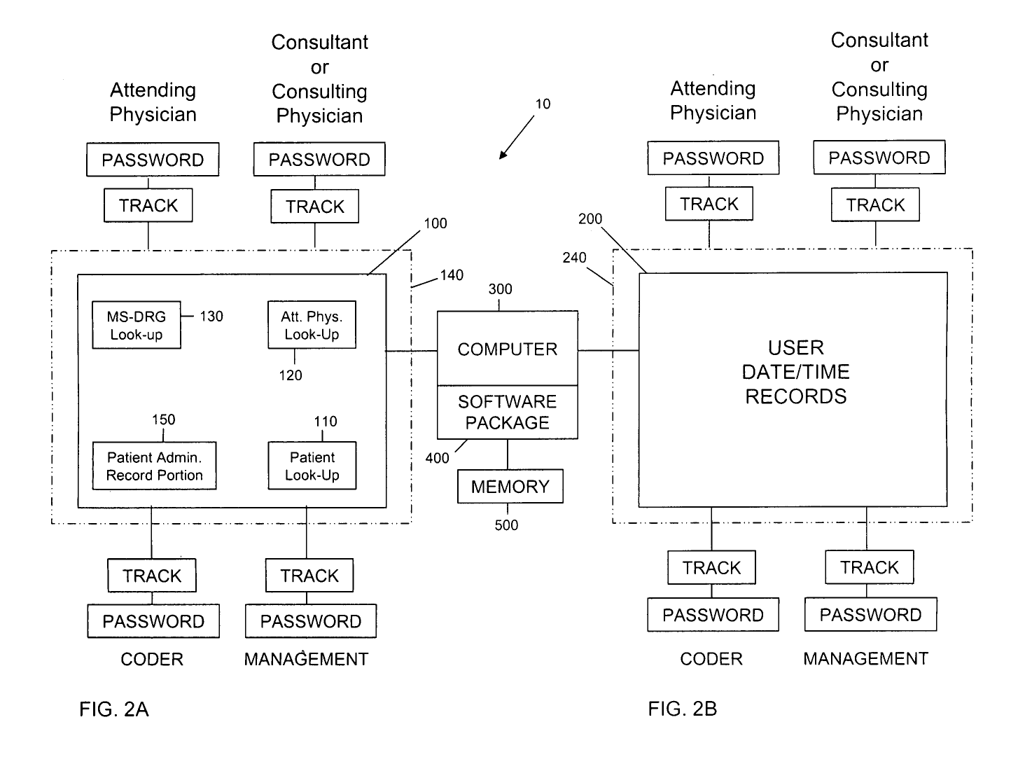

A general description of the system and method 10 of the present invention appears in FIGS. 2A and 2B. Specifically, the system and method 10 of the present invention includes two functions 100, 200.

The first function is a coding information recording function 100 as shown in FIG. 2A. The coding information recording function 100 includes the patient administrative record portion 150 into which MS-DRG coding information is added by the coder.

To assist the coder in creating that portion of the patient administrative record containing the MS-DRG code, the coder is provided with several look-up files 110, 120, and 130. Such look-up files may contain information such as patient information 110, attending physician information 120 and current MS-DRG information 130. The coder uses information from the look-up files to assist in proposing an MS-DRG code for entry into the patient administrative record.

As may be seen by further reference to FIG. 2A the coding information recording function is protected by a firewall 140 which is compliant with both HIPAA privacy requirements and other requirements under which a patient treatment facility may operate.

Access to the patient administrative record through the firewall 140 by the coder, the attending physician, the consulting physician, and management of the patient treatment facility is restricted by the use of a password system. Every entry or attempted entry through the fire wall to the patient administrative record generates a tracked entry of the identity of the user and the time and date of the attempted entry. The tracked entry information is recorded and maintained by the coding communication tracking function 200 shown in FIG. 2B.

The coding communication tracking function 200 shown in FIG. 2B is also protected by a firewall 240 which includes entry protections which meet both HIPAA requirements and other information security requirements applicable to the patient treatment facility. Access to the information retained in the coding communication tracking function 200 is available to the coder, the attending physician, the consulting physician, and the management of the patient treatment facility by the use of a password controlled entry. Information provided by the coding communication tracking function 200 may be in the form of a standard report created from information assembled from information stored in the coding communication tracking function 200 each time a request for information is made. Alternatively, information provided by the coding communication tracking function 200 may be in the form of a running report which is provided on the request of a user accessing the coding communication tracking function 200. In the flow charts which flow entries of date/time information into the communication tracking function 200 are designated by reference number 48.

A computer or computers 300 using the software package 400 enabling the system and method 10 of the present invention, together with one or more data storage facilities 500 is shown linking the two functions 100, 200 displayed in FIG. 2A and FIG. 2B. Those of ordinary skill in the art will understand that numerous different software and hardware architectures may be used to make the features and advantages of the disclosed system and method 10 available to users.

The system and method 10 of the present invention has been built as a Windows software based software package using a Microsoft.NET platform. Users of the disclosed system and method 10 will not need any additional software to install and run the software package 400 enabling the operation of the system and method 10 of the disclosed invention.

It is anticipated that the disclosed system and method 10 will be deployed in the intranet system of a patient treatment facility to be compliant with both HIPAA requirements and other requirements regarding the protection of sensitive business and management information. When fully installed the software package 400 enabling the disclosed system and method 10 will run alongside other software systems available to users within a patient treatment facility.

### Features Provided

Included in the disclosed system and method 10 are the following features which provide for the timely and accurate assignment of DS-MRG codes to a patient administrative record, recording of the information on which the selection of an MS-DRG code is based, and monitoring of the process of the entry of an MS-DRG code into a patient administrative record.

Patient treatment record information needed by the coder for the proper selection of a proposed MS-DRG codes to a patient administrative record is made available to those involved in the MS-DRG code assignment process for comparison to current directories of the vocabulary and numbering systems associated with MS-DRG codes.

Information provided in response to requests for information in the patient treatment record for the proper assignment of MS-DRG is placed in a format that is usable in the patient administrative record form adopted by a patient treatment facility.

Coders are provided with a standard template to use when requesting information from an attending physician to assist in the assignment of an MS-DRG code to a patient administrative record.

Coders are provided with an array of standard questions, customizable questions, and free form text fields for use when requesting information from an attending physician for the assignment of an MS-DRG code to a patient administrative record.

Requests from coders to attending physicians for information regarding the assignment of an MS-DRG code to a patient administrative record may be e-mailed by the coder to the attending physician by a communication link within the software package thereby eliminating the need for the coder to interrupt the process of creating that portion of the patient administrative record including an MS-DRG code to communicate with the attending physician.

Attending physicians are alerted to the receipt of a request for information from a coder regarding the assignment of an MS-DRG code to a patient administrative record.

Coder requests for information to an attending physician regarding the assignment of an MS-DRG code to a patient administrative record include a temporary embedded link to a patient treatment record. This embedded link to a patient treatment record assists the attending physician when providing the information needed by the coder to assign an MS-DRG code to a patient administrative record.

Attending physicians are provided with a standard template to provide a response to a coder request for information regarding the assignment of an MS-DRG code to a patient administrative record.

Attending physicians are provided with predefined response fields as well as free form text fields for providing coders with the information needed to assign an MS-DRG code to a patient administrative record.

The content of responses from attending physicians included in the communication back to the coder will be captured and stored by the coding information recording function.

If needed, an attending physician may forward a request for information from a coder or a specific request for assistance to a consultant or a consulting physician for additional information to enable a more complete response by the attending physician to a request from a coder for additional information with which to assign an MS-DRG code to a patient administrative record.

A consultant or a consulting physician asked to provide assistance in response to a request from an attending physician may be provided with a temporary embedded link to patient treatment information to enable responding to the request for assistance from the attending physician.

If a consultant or a consulting physician is asked to provide assistance at the request of an attending physician, the consultant or consulting physician is provided with one or more predefined response fields as well as free form text fields in which the assistance requested by the attending physician may be provided to the attending physician.

Both the attending physician and the consultant or consulting physician may be provided with a standard phrase library which may be used to facilitate a faster response to a request for information from the coder. The standard phrase library is accessible by an embedded link in the e-mail message response screen.

As indicated above, users of the system and method of the present invention are provided with a look-up table of MS-DRG codes and supporting codes from publicly available sources. Such MS-DRG code information may include annotations or special instructions provided by the patient treatment facility.

Access to MS-DRG codes may be accompanied by a searching tool to enable greater access to MS-DRG definitions and vocabulary changes or updates.

Security controls to protect patient privacy and sensitive information are changeable to assure adherence to the most updated security controls imposed on information contained in both the coding information recording function and in the coding communication tracking function.

Levels of access to certain items of information in a patient treatment record, a patient administrative record and within the coding communication tracking function may be established depending on the type of information and the entitlement of the requester to view certain types of information.

Password access controls are established for the following:

coder access to a patient treatment record;

coder access to information stored in either the coding information recording function or in the coding communication tracking function;

physician access to the patient treatment record;

consultant or consulting physician access to the patient treatment record;

patient treatment facility management access granted to the patient treatment record;

any access granted to the patient administrative record.

The screen provided to the coder to request information from the attending physician regarding the assignment of an MS-DRG code to a patient administrative record contains required fields for the search and retrieval of information including:

patient Medical Record Number;

patient name;

attending physician name and/or medical staff number;

attending physician e-mail address.

A signature system indicating the approval of an attending physician to the information provided to a coder regarding the assignment of an MS-DRG code to a patient administrative record, including:

a requirement that an electronic signature be included on all responses by attending physicians to a request for information requesting the assignment of an MS-DRG code to a patient administrative record from a coder;

a transmission block that will not allow a response to a coder request for information to be transmitted without the electronic signature of the attending physician;

an authentication accompanying the electronic signature of the attending physician using words such as “I attest and verify the information contained in this response to be true . . . ”;

the necessary information fields required to support the authenticity statement of the attending physician;

a prompt to an attending physician indicating that a response cannot be sent to a coder without an approval of the authenticity statement of the physician;

a prompt to an attending physician indicating that a response will not be sent without the attachment of an electronic signature;

a requirement that the attending physician register a physician number and an e-mail address for access by users of the system and method of the present invention.

The system and method of the present invention will store all requests for information to be used in assigning an MS-DRG code to a patient administrative record and all responses received to the requests for information to be used in assigning an MS-DRG code to a patient administrative record.

The imbedded link to the patient treatment record to be used by an attending physician or a consultant or consulting physician will be terminated upon the transmission of a response to the coder request for information to be used in the assignment of an MS-DRG code to a patient administrative record.

A reminder e-mail message will be sent to an attending physician if a response to a coder request for information regarding the assignment of an MS-DRG code to a patient administrative record is not received by the coder within a predetermined time. Such e-mail reminder message will include the following information:

a designation that the e-mail reminder message is a reminder message appearing within the subject line of the e-mail reminder message;

a recapture of the embedded link to the patient treatment record that originally appeared in the coder request for information to be used in the assignment of an MS-DRG code to a patient administrative record with no intervention capability provided to the coder.

If multiple communications between the coder and the attending physician are necessary, a record of all such communications will be maintained. Such multiple communications may:

be made without an embedded link to the patient treatment record;

be made to consultants or consulting physicians with or without an embedded link to a patient treatment record;

include communication from a consultant or consulting physician within the e-mail communication from the attending physician to the coder in response to the request for information regarding the assignment of an MS-DRG code to a patient administrative record.

The management of a patient treatment facility will be able to obtain reports that track information regarding coder requests for information requesting information to assist in the assignment of an MS-DRG code to a patient administrative record to include:

number of coder requests for information from attending physicians for information regarding the assignment of an MS-DRG code to a patient administrative record that have not been answered;

identifying patient information associated with coder requests for information that from attending physicians for information regarding the assignment of an MS-DRG code to a patient administrative record that have not been answered;

the date/time that a request for information regarding the assignment of an MS-DRG code to a patient administrative record was sent to an attending physician;

the time taken by an attending physician to respond to the coder request for information regarding the assignment of an MS-DRG code to a patient administrative record;

the average time taken by an attending physician or a selected group of attending physicians to respond to the requests of one or more coders for information regarding the assignment of an MS-DRG code to a patient administrative record.

Patient treatment facility management will also be able to focus on individual aspects of the process of assigning, recording and managing MS-DRG codes to patient administrative records by obtaining reports including:

activities of individual coders;

activities of individual attending physicians;

activities with respect to certain MS-DRG codes;

activities with regard to certain combinations of parameters describing the operation of the process of assigning, recording and managing MS-DRG codes in patient administrative records.

By use of the foregoing features, both coders and attending physicians can consolidate and manage all of the coder requests for additional information to assist in the assignment of an MS-DRG code to a patient administrative record in a single system.

By use of the foregoing features, attending physicians will only be able to temporarily gain access to the sensitive information in a patient treatment record using the embedded link provided in the e-mail message from the coder requesting information about the assignment of an MS-DRG code to a patient administrative record.

By use of the foregoing features, those of ordinary skill in the art will understand that attending physicians can approve/disapprove/verify/identify MS-DRG codes assigned to a patient administrative record with minimal input to communication sent in response to a coder request for information regarding the assignment of an MS-DRG code to a patient administrative record.

By use of the foregoing features, coders, attending physicians, consultants or consulting physicians can receive notification of the status of coder requests for information, responses to coder requests for information, or other status information describing the interaction between the coder and the attending physician regarding the assignment of an MS-DRG code to a patient administrative record.

By use of the foregoing features, coders, attending physicians, consultants or consulting physicians are provided convenient access to a table of MS-DRG codes which access improves the accuracy of the assignment of MS-DRG codes by a coder to a patient administrative record.

### Operational Example

A still better understanding of the system and method of the present invention may be had by an illustrative operational example.

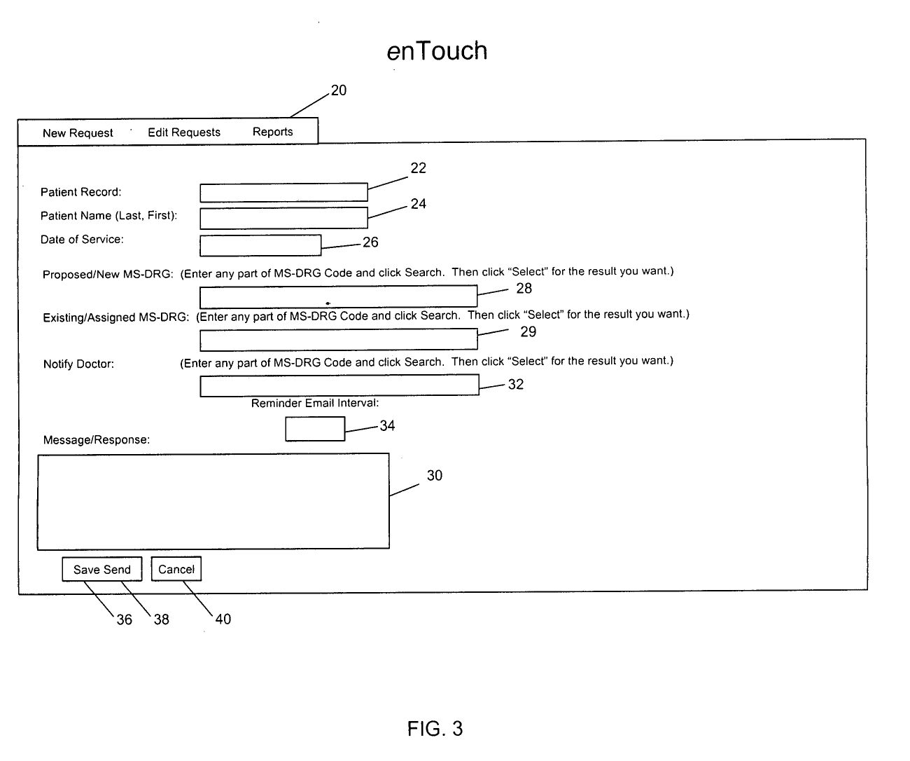

Shown in FIG. 3 is a screen 20 provided to a coder when beginning the process of creating that portion of a patient administrative record combining an MS-DRG code. Blocks are provided for the entry of identifying information such as the patient record number 22, the patient's name 24 and the date 26 that health care services were provided to the patient by the patient treatment facility.

In the middle of the screen 20 shown in FIG. 3 is a block 28 indicating the current proposed MS-DRG code for which the coder requires additional information to make a proper physician-approved assignment. Also included is a block 29 for entry of an existing or assigned MS-DRG code if such existing or assigned MS-DRG code exists. Specific questions regarding the information needed or a free form text request is included in the box 30 at the bottom of the screen 20. The name of the attending physician is placed in the box 32 in the middle of the screen shown in FIG. 3. As previously indicated, the screen 20 shown in FIG. 3 may be supplemented with look-up screens including MS-DRG codes, information regarding the patient and information regarding the attending physician. If desired the coder may set the time 34 for a reminder message in case a response is not received from the attending physician for the requested information. Alternatively, the patient treatment facility may designate a standard time for the dispatch of a reminder message.

At the bottom of the screen 20 shown in FIG. 3 are three boxes. The first box 36 enables saving a partially completed screen if the coder is interrupted before being able to send a request for information. The second box 38 sends the request for information to the attending physician. The third box 40 enables the coder to cancel the partially completed screen and begin again if needed.

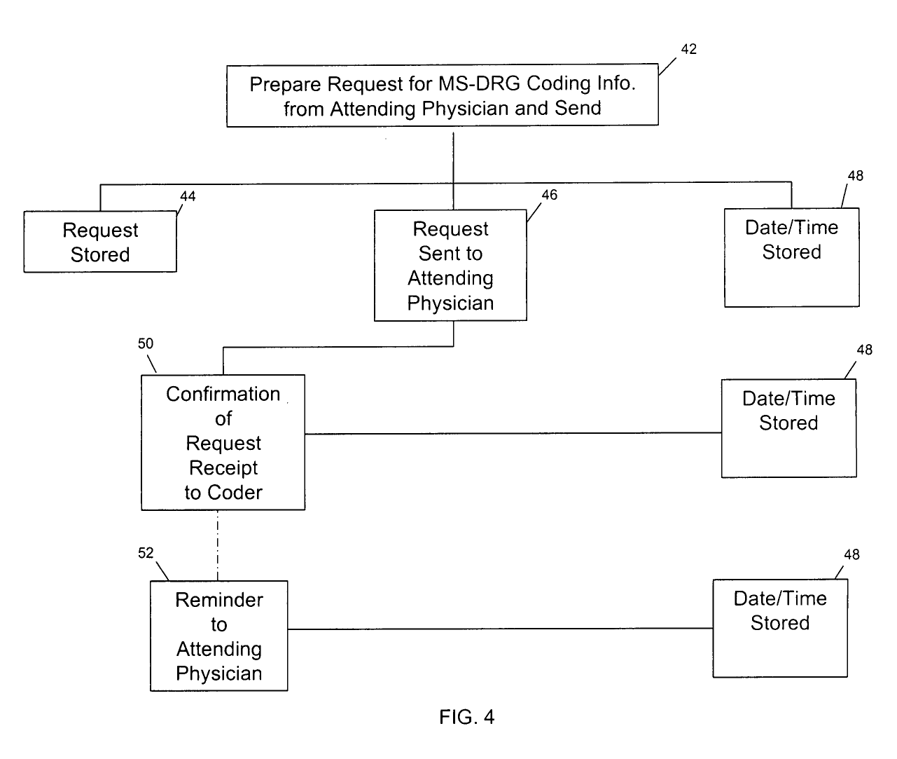

FIG. 4 tracks the flow of the request of the coder for additional information from the attending physician to assign an MS-DRG code to a patient administrative record. Once the request to the attending physician is prepared 42, as described above with respect to the screen shown in FIG. 3 and the SEND button 38 at the bottom of the screen 20 shown in FIG. 3 is activated, three things happen. First, the request for information is stored 44 at a location within memory 500 designated by the computer or computers 300 shown between FIG. 2A and FIG. 2B. Second the coder request for information is sent to the attending physician 46. As indicated in FIG. 2B, a record is stored 48 in the coding communication tracking function 200 of the transmission of the coder request for information to the attending physician. Completion of the transmission of the coder request to the attending physician 50 is recorded and stored 48 in the coding communication tracking function 200 shown in FIG. 2B. If the coder request to the attending physician is not completed a notification is provided to the coder. If the attending physician has not provided a response to the coder request for information within a predetermined time, a reminder e-mail message 52 is automatically generated and recorded by the coding communication tracking function 200.

As previously indicated the information contained within the coding communication tracking function 200 may be drawn as needed and put into one of a variety of report formats available to a requester. Alternatively, a running report of coding communication may be maintained at all times. If a running report is made available, those monitoring the coder requests for information regarding the assignment of an MS-DRG code to a patient administrative record may gain quick access to the status of coding communications whenever needed.

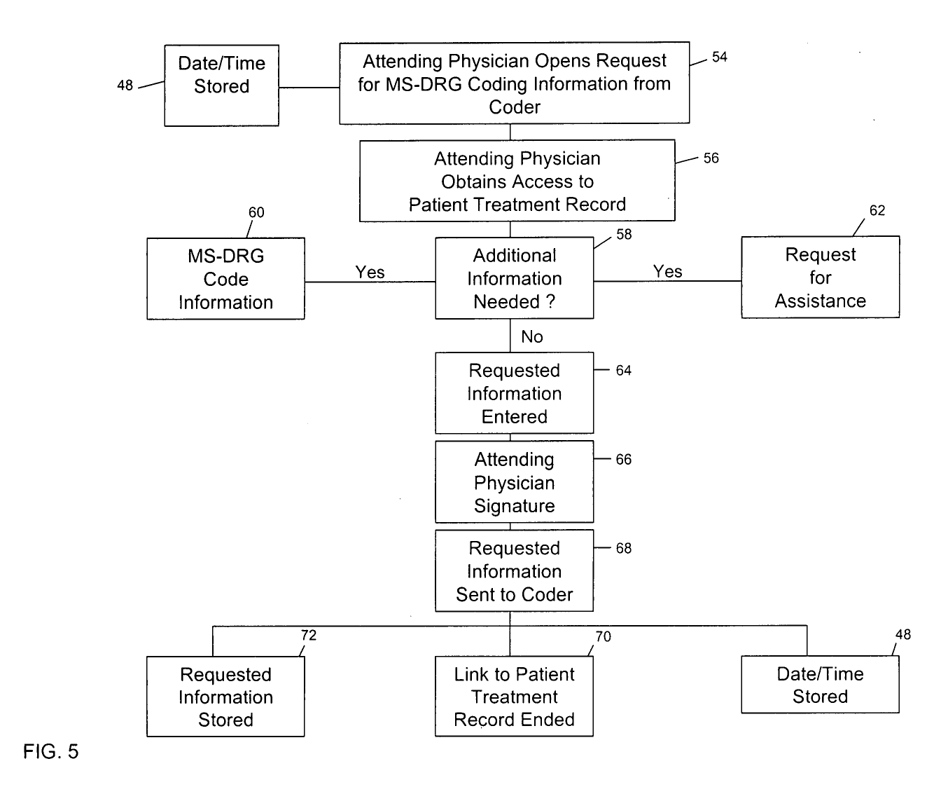

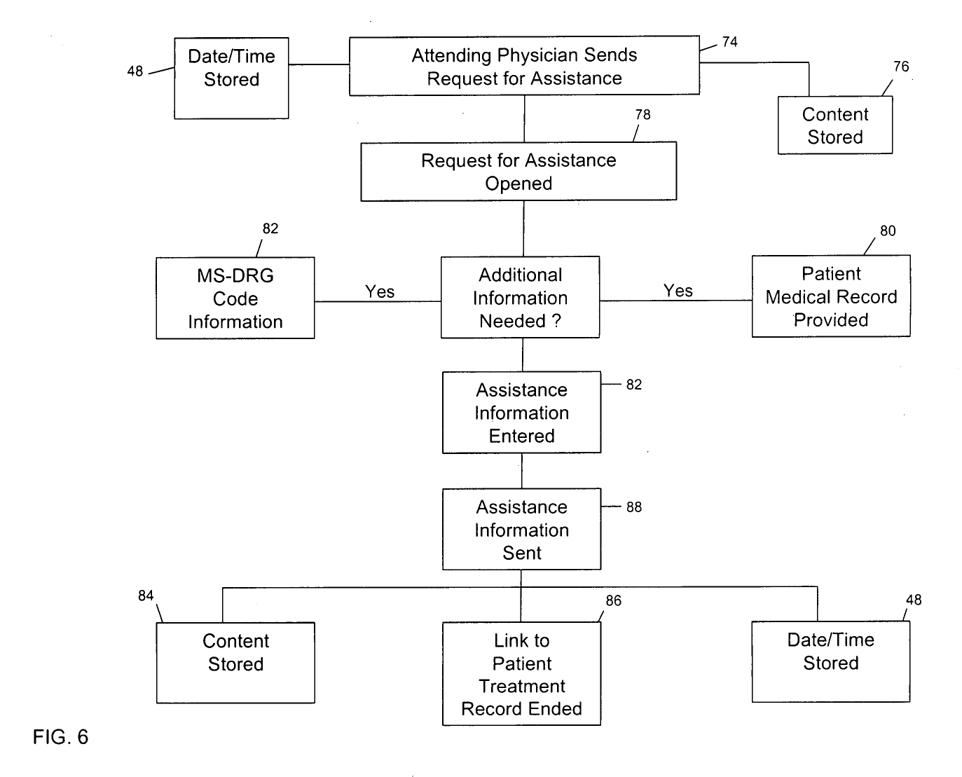

FIG. 5 designates the activity of the attending physician upon opening the coder request for information 54 regarding the assignment of an MS-DRG code to a patient administrative record. Notation of the time of the opening of the coder request for information is stored 48 in the coding communication tracking function 200. Included with the first request of the coder for information is an embedded link to the patient treatment record to enable the attending physician to gain access 56 to notations previously made by him/herself or other health care professionals in patient treatment record. If additional information is needed 58 by the attending physician, the attending physician may consult a look-up table including MS-DRG code vocabulary and numbering information 60. Alternatively, the attending physician may desire to ask for assistance 62 from a consultant or consulting physician. FIG. 6 describes the sequence of events if a consultant or consulting physician is used by the attending physician.

If additional information is not needed by the attending physician to respond to the coder request for information, the attending physician enters the requested information 64 in a predetermined format, a suggested format or in free form text. Authentication of the input provided by the attending physician is provided by the affixation of the electronic signature of the attending physician 66. Once the electronic signature of the attending physician is affixed to the response provided to the coder, the response is sent by the attending physician to the coder 68.

The sending of the response by the attending physician to the coder 68 does three things. First, the embedded link to the patient treatment information is terminated 70. Second, a record 48 is stored in the coding communication tracking function 200 of the date and time that the attending physician provided the requested information to the coder. Third, the response of the attending physician is stored 72 in the coding information recording function 100.

If the attending physician has questions or comments regarding the coder request for information, the attending physician may initiate clarifying communication with the coder. Such clarifying communication may or may not include an electronic signature depending on the policy of the patient treatment facility. However, details regarding the transmission and receipt of the clarifying communication will be recorded in the coding communication tracking function 200. In subsequent communication between the coder and the attending physician the embedded link to the patient treatment record will not be provided unless specifically requested by the attending physician.

FIG. 6 describes the sequence of events if the attending physician seeks the assistance of a consultant or a consulting physician 74 when responding to a coder request for information regarding the assignment of an MS-DRG code to a patient administrative record. The content of the actual request of the attending physician for assistance to the consultant or consulting physician is recorded 76 in the coding information recording function 100. The sending of a request by an attending physician to a consultant or a consulting physician for assistance is stored 48 by the coding communication tracking function 200 as is the receipt of the request for assistance from the consultant or consulting physician 78. The opening of the request for assistance by the consultant or the consulting physician is stored 48 by the coding communication tracking function 200. The consultant or consulting physician may also be provided with an embedded link to the patient treatment record 80 as well as a look-up table of current MS-DRG coding information 82.

When the consultant or consulting physician provides the assistance 88 requested by the attending physician, three things happen. First, the information provided in response to the request for assistance from the consulting physician is stored 84 in the coding information recording function 100. Second, the embedded link to the patient treatment record is terminated 86. Third, the coding communication tracking function 200 stores 48 a record of the date and time the response to the request for assistance was sent 88 to the attending physician by the consultant or consulting physician.

Depending on the policy of patient treatment facility the consultant or consulting physician may be substituted for the attending physician and future communication from the coder regarding the assignment of an MS-DRG code to a patient administrative record may be directed to the consultant or consulting physician by the coder instead of the attending physician.

The coding communication tracking function 200 records the receipt of the response to the request for assistance by the consultant or consulting physician and the date and time that the attending physician opens the message from the consultant or consulting physician.

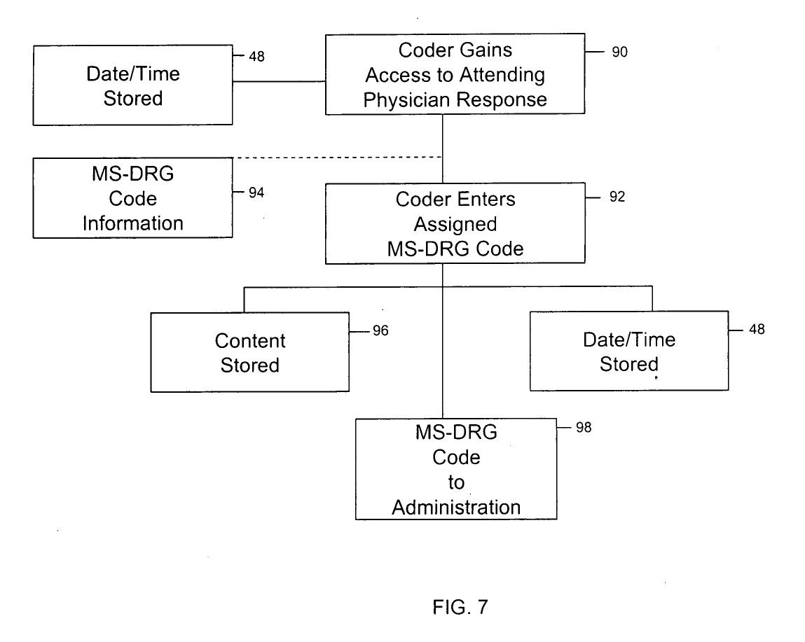

FIG. 7 describes the sequence of events following the receipt of an authenticated response from an attending physician by a coder including information needed for the assignment of an MS-DRG code to a patient administrative record. The receipt of the message from the attending physician to the coder is recorded in the coding communication tracking function 200. The date and time of the opening of the message from the attending physician by the coder 90 is also tracked 48. With the information provided by the attending physician, the coder enters an assigned MS-DRG code 92 into the patient administrative record. If needed the coder may consult a look-up table 94 including the most current information on MS-DRG codes.

Once the MS-DRG code has been assigned by the coder to a patient administrative record, the patient administrative record is sent to the administration section of the patient treatment facility 98 for record keeping or billing purposes. This transmission from the coder to the administration section of the patient treatment facility is stored 96 in the coding information recording function and the date and time is tracked in the coding communication tracking function 200. Those with access to the patient administrative records in the administration section of the patient facility may now gain access to the patient administrative record. Either the coding communication tracking function 200 of the disclosed system and method or a separate system associated with the administrative section of the patient treatment facility records any information about those who seek access to the patient administrative record as well as the date and time of such requested access to the patient administrative record.

In some situations, a patient treatment facility may create a document which some patient treatment facilities call a “Final Report To The Permanent Medical Record”. This report is an abstract from both the patient treatment record and the patient administrative record including only essential information. Such reports typically include the patient name, the medical record number, the date(s) of service, one or more assigned MS-DRG codes, the name of the attending physician(s) and an attestation along with an electronic signature. The information stored within the patient coding information recording function 100 and in the coding communication tracking function 200 of the system and method of the present invention may be flagged and later extracted for inclusion in the Final Report To The Permanent Medical Record.

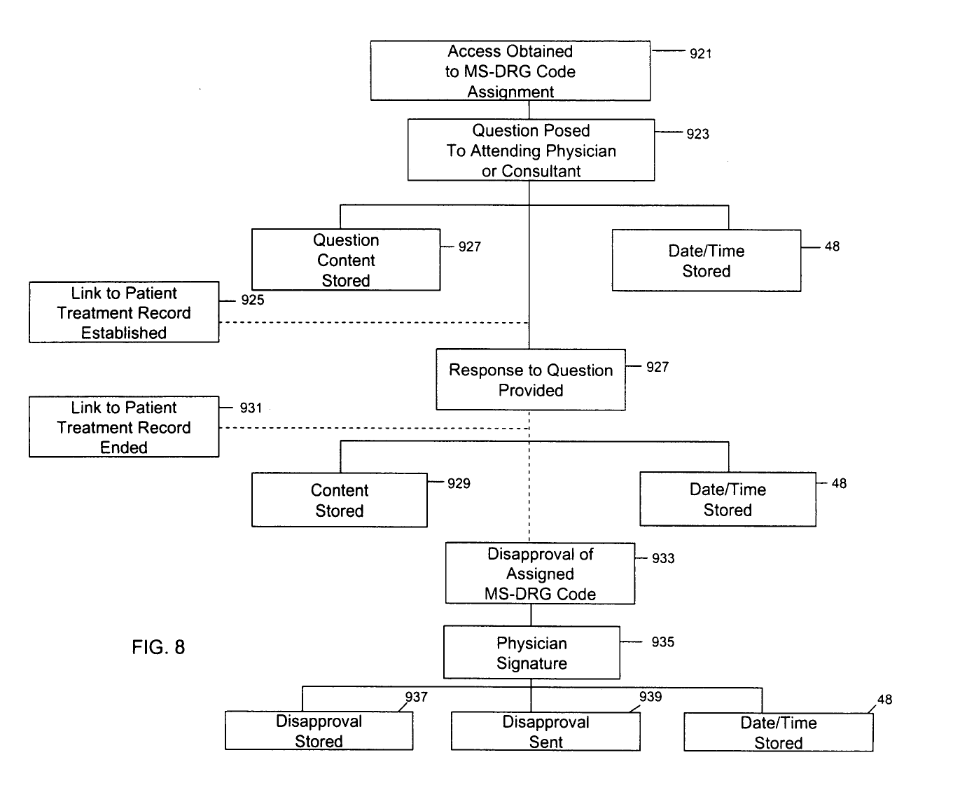

In some unique situations problems arise regarding the information provided by the attending physician to the coder request for information regarding the assignment of an MS-DRG code or the actual MS-DRG code included in the patient administrative record. FIG. 8 provides an example of the response of the system and method of the present invention to such unique situations.

As shown in FIG. 8 the administration or management of the patient treatment facility has gained access to the MS-DRG code in the patient administrative record 921 and has a question about the information provided by either the attending physician, the consultant or the consulting physician. In such case the administration or management of the patient treatment facility may need to pose a question about the assignment of an MS-DRG code to a patient administrative record or a related matter to the attending physician, the consultant or the consulting physician 923. Such question may or may not include an embedded link 925 to the patient treatment record. As in previous communications, the content of the question posed is stored 927 in the coding information recording function 100. Further, information recording the transmission and receipt of the question is stored 48 in the coding communication tracking function. When the recipient of the question provides an answer to the question 927, the answer to the question is stored 929, the access to the patient treatment record is terminated 931 and the tracking function stores 48 the details regarding the communication exchange.

As shown at the bottom of FIG. 8, if a physician within the administration or the management of the patient treatment facility assigns an MS-DRG code to a patient administrative record with which the attending physician, the consultant or the consulting physician disagrees—the attending physician, the consultant or the consulting physician may record such disapproval 933 along with an authenticating signature 935. Once again the content of all communication is stored 937 in the coding information recording function 100 as are the dates and time of such communication stored 48 by the coding communication tracking function 200 when the disapproval is sent 939.

In yet other situations, the administration or management of the patient treatment facility may need to pose a question regarding a particular patient or some other matter related the general health care provided in the patient treatment facility. By use of the system and method of the present invention such general questions regarding a particular patient or some other matter related to the health care provided in the patient treatment facility may be recorded and tracked. Such questions may be directed to one or all of the coder, the attending physician, the consultant or consulting physician, a nurse, a technician or some other healthcare worker. As answers are provided, such answers may be recorded and tracked just like the answers provided by an attending physician regarding the assignment of an MS-DRG code to a patient administrative record.

### Reports

As indicated above the present invention provides all of those involved with the process of entering MS-DRG codes into individual patient administrative records with the ability to check on the status of the work done on individual patient administrative records as well as providing reports on how well the system and method of the disclosed invention is working in a patient treatment facility.

Management of patient treatment facility will be able to produce a variety of reports, each of which can be put together by the software package enabling the disclosed system and method. The requester of the report will need a password to request and produce a report. Such reports designed for the management of a patient treatment facility regarding individual patient administrative records include:

status of an individual coder request to an attending physician for information regarding the assignment of an MS-DRG code to a patient administrative record;

status of an individual coder request to an attending physician for information regarding assignment of an MS-DRG code to a patient administrative record by patient;

requests for information by coder to an attending physician for information regarding assignment of an MS-DRG code to a patient administrative record by request for information opening date;

requests for information by coder to an attending physician for information regarding assignment of an MS-DRG code to a patient administrative record by request for information closing date;

requests for information by coder to an attending physician for information regarding assignment of an MS-DRG code to a patient administrative record during a predetermined time period;

requests for information to an attending physician for information regarding assignment of an MS-DRG code to a patient administrative record by coder;

requests for information to an attending physician for information regarding assignment of an MS-DRG code to a patient administrative record by assigned MS-DRG code;

requests for information to an attending physician for information regarding assignment of an MS-DRG code to a patient administrative record by status;

requests for information to an attending physician for information regarding assignment of an MS-DRG code to a patient administrative record by proposed MS-DRG code; and

requests for information to an attending physician regarding assignment of an MS-DRG code to a patient administrative record by attending physician.

As indicated above the accurate and efficient operation of the MS-DRG code assignment system is an essential part of the ability of the ability of the patient treatment facility to recover monies for the health care services provided to patients. Thus, in addition to spotting errors in the placement of an MS-DRG code into an individual patient administrative record, the management of a patient treatment facility also has an interest in how the MS-DRG code assignment system is working throughout the patient treatment facility. Accordingly, the software package enabling the system and method 10 of the present invention will produce the following reports for a request which provides access to the report producing utility of the software package 400 by use of a password:

average time between the initiation of requests for information regarding assignment of an MS-DRG code to a patient administrative record by a coder and the supply of information regarding the assignment of an MS-DRG code to a patient administrative record by attending physicians; and

average time between the initiation of a request for information regarding the assignment of an MS-DRG code to a patient administrative record by a coder to an attending physician and the supply of information regarding the assignment of an MS-DRG code to a patient administrative record by the attending physician to the coder.

As the present system regarding the assignment of an MS-DRG code to the patient administrative record begins and ends with the coder, it is important that the coder be able to keep track of his/her work. Accordingly, the following list of password accessible reports are available to a coder:

requests to attending physicians for information regarding the assignment of an MS-DRG code to a patient administrative record that have not been accessed by an attending physician;

requests to attending physicians for information regarding the assignment of an MS-DRG code to a patient administrative record that have been accessed by the attending physician but have not been answered by the attending physician; and

requests to attending physicians for information regarding the assignment of an MS-DRG code to a patient administrative record that have been answered by the attending physician.

The best use of the time of an attending physician is to see patients to evaluate injuries, diseases, or maladies and the recommend or perform the needed health care treatment. Responding to questions from coders regarding the assignment of an MS-DRG code to a patient administrative record should be simplified to save time for the attending physician to evaluate and treat patients. Accordingly, the attending physician has password access to the following reports:

requests from coders for information regarding the assignment of an MS-DRG code to a patient administrative record that have been sent from a coder, but which remain unanswered;

requests from coders for information regarding the assignment of an MS-DRG code to a patient administrative record that have been accessed by remain unanswered;

requests from coders for information regarding the assignment of an MS-DRG code to a patient administrative record that have been answered;

Delays in the completion of patient administrative records can affect the cash flow into a patient treatment facility. For example, even a delay of one day can cause a bill to a patient or to an insurance company to slip to a later billing cycle—which later billing cycle may be as much as thirty days away. Accordingly, reminders are a key part of the disclosed system and method. Thus the system and method of the present invention provides reminders of work that needs to be done regarding the assignment of an MS-DRG code to a patient administrative record to coders, attending physicians and patient treatment facility management.

Those involved with the assignment of MS-DRG codes to patient administrative records such as coders, attending physicians, consulting physicians and patient treatment facility management will observe the following advantages from use of the disclosed system and method:

reduced difficulty for coders in reaching physicians to lodge requests for the additional information needed to assign an MS-DRG code to a patient administrative record;

reduction in inaccurate or unusable information provided by attending physicians regarding the assignment of an MS-DRG code to a patient administrative record;

increased use of the most current MS-DRG codes for inclusion in a patient administrative record;

increased communication between attending physicians and coders regarding the assignment of MS-DRG codes to a patient administrative record.

Those involved with the management of a patient treatment facility will realize the following advantages from use of the system and method of the disclosed invention:

a measurement tool to evaluate the effectiveness, accuracy and efficiency of system for the inclusion of an MS-DRG code in a patient administrative record;

better use of the time of a coder in creating accurate patient administrative records;

better use of the time of an attending physician in providing the information needed by a coder to accurately assign an MS-DRG code to a patient administrative record;

increased cash flow to a patient treatment facility by reducing receivables associated with patient administrative records lacking an MS-DRG code or including an improper MS-DRG code and reducing the time between patient intake and the billing for health care services provided by the patient treatment facility;

increased compliance with health care regulations by increased awareness of the health care treatment status of the patients requesting health care services from a patient treatment facility;

facilitated exchange of information exchange by use of standard forms for the recordation of information;

greater traceability of information in the case of the assignment of an inaccurate MS-DRG code to a patient administrative record;

greater documentation for assessing accountability of those involved in the assignment of an MS-DRG code to a patient administrative record.

easier and faster creation of permanent records maintained voluntarily by a patient treatment facility or mandated by regulatory or accreditation agencies

While the disclosed system and method has been disclosed according to its features and further explained by use of an illustrative. example, those of ordinary skill will understand that the disclosed system and method may be implemented according to a variety of different software and hardware architectural schemes to provide the same or similar advantages described above. Others of ordinary skill in the art will understand that modifications may be made to increase the utility of the disclosed invention. Such software and hardware architectural schemes along with modifications to the disclosed system and method shall be included within the scope and meaning of the appended claims.

What is claimed is:

1. A computer controlled system for assigning, recording, and managing MS-DRG coding in a patient treatment facility, said computer controlled system comprising:
a coding information recording function including:
a coder created patient administrative record portion including patient identification, attending physician identification, MS-DRG coding, and message space;
said coder created record patient administrative record portion being password accessible to said coder, said attending physician and patient treatment facility management;
a communication link between said coder and said attending physician for approval/disapproval of an MS-DRG code;
a coding communication tracking function including:
a tracking record of the identification and the date/time of those seeking access to said coder created patient record;
said tracking record being password accessible to one or more of said coders, said attending physicians and said patient treatment facility management.

2. The computer controlled system as defined in claim 1 wherein said coder created patient administrative record portion is protected by a HIPAA compliant firewall.

3. The computer controlled system as defined in claim 1 wherein said tracking record is protected by a HIPAA compliant firewall.

4. The computer controlled system as defined in claim 1 wherein said communication link enables the exchange of information between said coder and said attending physician regarding the assignment of an MS-DRG code to said coder created patient administrative record portion.

5. The computer controlled system as defined in claim 1 wherein said coder and said attending physician are provided access to one or more look-up tables when accessing said coder created patient administrative record portion, said one or more look-up tables being selected from a group including: patient name, attending physician name and MS-DRG code information.

6. The computer controlled system as defined in claim 1 wherein said patient treatment facility management is able to use said coding information recording function and said coding communication tracking function to provide one or more password accessible reports, said one or more password accessible reports being selected from a group including:
status of an individual coder request to an attending physician for information regarding assignment of an MS-DRG code;
status of an individual coder request to an attending physician for information regarding assignment of an MS-DRG code by patient;
requests for information by coder to an attending physician for information regarding assignment of an MS-DRG code by request for information opening date;
requests for information by coder to an attending physician for information regarding assignment of an MS-DRG code by request for information closing date;
requests for information by coder to an attending physician for information regarding assignment of an MS-DRG code during a predetermined time period;
requests for information to an attending physician for information regarding assignment of an MS-DRG code by coder;
requests for information to an attending physician for information regarding assignment of an MS-DRG code by assigned MS-DRG code;
requests for information to an attending physician for information regarding assignment of an MS-DRG code by status;
requests for information to an attending physician for information regarding assignment of an MS-DRG code by suggested MS-DRG code; and
requests for information to an attending physician for information regarding assignment of an MS-DRG code by an attending physician.

7. The computer controlled system as defined in claim 1 wherein said patient treatment facility management is able to use said coding information recording function and said coding communication tracking function to obtain one or more password accessible reports, said one or more password accessible reports being selected from a group including:
average time between the initiation of requests for information regarding assignment of an MS-DRG code by a coder and the supply of the information regarding the assignment of an MS-DRG code by attending physicians;
average time between the initiation of a request for information regarding the assignment of an MS-DRG code by a coder to an attending physician and the supply of information regarding the assignment of an MS-DRG by an attending physician to the coder; and
information maintained by a patient treatment facility in a permanent record.

8. The computer controlled system as defined in claim 1 wherein said coder is able to use said coding information recording function and said coding communication tracking function to obtain one or more password accessible status reports, said one or more password accessible status reports being selected from a group including:
requests to attending physicians for information regarding the assignment of an MS-DRG code that have not been accessed by said attending physician;
requests to attending physicians for information regarding the assignment of an MS-DRG code that have been accessed by the attending physician but have not been answered by the attending physician; and
requests to attending physicians for information regarding the assignment of an MS-DRG code that have been answered by an attending physician.

9. The computer controlled system as defined in claim 1 wherein said attending physician is able to use said coding information recording function and said coding communication tracking function to obtain one or more password accessible status reports, said one or more password accessible status reports including:
requests from coders for information regarding the assignment of an MS-DRG code that have been sent from a coder which remain unanswered;
requests from coders for information regarding the assignment of an MS-DRG code that have been accessed but remain unanswered; and
requests from coders for information regarding the assignment of an MS-DRG code that have been answered.

10. The computer controlled system as defined in claim 11 wherein said coding information recording function and said coding communication tracking function are used to send reminders of unanswered requests for information regarding the assignment of an MS-DRG code to one or more recipients selected from a group including:
coders;
attending physicians;
patient treatment facility management.

11. A computer controlled system for assigning, recording, and managing MS-DRG coding in a patient treatment facility, said computer controlled system comprising:
a coding information recording function including:
a coder created patient administrative record portion including patient identification, attending physician identification, MS-DRG coding, and message space;
said coder created record patient administrative record portion being password accessible to said coder, said attending physician, a consultant or consulting physician selected by said attending physician and patient treatment facility management;
a communication link between said attending physician and said consultant or consulting physician;
a communication link between said coder and said attending physician for approval/disapproval of an MS-DRG code;
a coding communication tracking function including:
a tracking record of the identification and the date/time of those seeking access to said coder created patient record;
said tracking record being password accessible to one or more said coders, said attending physicians, said consultant or consulting physician and said patient treatment facility management.

12. The computer controlled system as defined in claim 11 wherein said coder created patient administrative record portion is protected by a HIPAA compliant firewall.

13. The computer controlled system as defined in claim 11 wherein said tracking record is protected by a HIPAA compliant firewall.

14. The computer controlled system as defined in claim 1 wherein said communication link enables the exchange of information between said coder and said attending physician regarding the assignment of an MS-DRG code to said coder created patient administrative record portion.

15. The computer controlled system defined in claim 11 wherein said communication link between said attending physician and said consultant or consulting physician enables said attending physician to request assistance regarding responding to a request from a coder for information regarding the assignment of an MS-DRG code to said coder created patient administrative record portion.

16. The computer controlled system as defined in claim 11 wherein said coder, said attending physician and said consultant or consulting physician are provided access to one or more look-up tables when accessing said coder created patient administrative record portion, said one or more look-up tables being selected from a group including patient name, attending physician name and MS-DRG code information.

17. The computer controlled system as defined in claim 11 wherein said patient treatment facility management is able to use said coding information recording function and said coding communication tracking function to provide one or more password accessible reports, said one or more password accessible reports being selected from a group including:
status of an individual coder request to an attending physician for information regarding assignment of an MS-DRG code;
status of an individual coder request to an attending physician for information regarding assignment of an MS-DRG code by patient;
requests for information by coder to an attending physician for information regarding assignment of an MS-DRG code by request for information opening date;
requests for information by coder to an attending physician for information regarding assignment of an MS-DRG code by request for information closing date;
requests for information by coder to an attending physician for information regarding assignment of an MS-DRG code during a predetermined time period;
requests for information to an attending physician for information regarding assignment of an MS-DRG code by coder;
request or assistance by an attending physician to a consultant or a consulting physician to provide information regarding assignment of an MS-DRG code by coder;
requests for information to an attending physician for information regarding assignment of an MS-DRG code by assigned MS-DRG code;
requests for information to an attending physician for information regarding assignment of an MS-DRG code by status;
requests for information to an attending physician for information regarding assignment of an MS-DRG code by suggested MS-DRG code; and
requests for information to an attending physician for information regarding assignment of an MS-DRG code by attending physician.

18. The computer controlled system as defined in claim 11 wherein said patient treatment facility management is able to use said coding information recording function and said coding communication tracking function to obtain one or more password accessible reports, said one or more password accessible reports being selected from a group including:
average time between the initiation of requests for information regarding assignment of an MS-DRG code by a coder and the supply of the information regarding the assignment of an MS-DRG code by attending physicians;
average time between the initiation of a request for information regarding the assignment of an MS-DRG code by a coder to an attending physician and the supply of information regarding the assignment of an MS-DRG by an attending physician to the coder;
average time between the initiation of a request for assistance by an attending physician to a consultant or consulting physician and the supply of the requested assistance to the attending physician by the consultant or consulting physician; and
information maintained by a patient treatment facility in a permanent record.

19. The computer controlled system as defined in claim 11 wherein said coder is able to use said coding information function and said coding communication tracking function to obtain one or more password accessible status reports, said one or more password accessible status reports being selected from a group including:
requests to attending physicians for information regarding the assignment of an MS-DRG code that have not been accessed by said attending physician;
requests to attending physicians for information regarding the assignment of an MS-DRG code that have been accessed by the attending physician but have not been answered by the attending physician;
requests by attending physician to a consultant or consulting physician for assistance that have not bee answered; and
requests to attending physicians for information regarding the assignment of an MS-DRG code that have been answered by an attending physician.

20. The computer controlled system as defined in claim 11 wherein said attending physician is able to use said coding information recording function and said coding communication tracking function to obtain one or more password accessible status reports, said password accessible status reports including:
requests from coders for information regarding the assignment of an MS-DRG code that have been sent from a coder which remain unanswered;
requests from coders for information regarding the assignment of an MS-DRG code that have been accessed but remain unanswered;
requests for assistance to consultants or consulting physician that have not been answered; and
requests from coders for information regarding the assignment of an MS-DRG code that have been answered.

21. The computer controlled system as defined in claim 11 wherein said coding information recording function and said coding communication tracking function are used to send reminders of unanswered requests for information regarding the assignment of an MS-DRG code to one or more recipients selected from a group including:
coders;
attending physicians;
consultants or consulting physician
patient treatment facility management.

22. A computer controlled method for assigning, recording, and managing MS-DRG coding in a patient treatment facility, said computer controlled method comprising the steps of:
creating a coding information recording function within a software package operable on the computer, said coding information recording function including:
a coder created patient administrative record portion including patient identification, attending physician identification, MS-DRG coding, and message space;
said coder created record patient administrative record portion being password accessible to said coder, said attending physician and patient treatment facility management;
a communication link between said coder and said attending physician for approval/disapproval of an MS-DRG code;
creating a coding communication tracking function within said software package operable on the computer, said coding communication tracking function including:
a tracking record of the identification and the date/time of those seeking access to said coder created patient record;
said tracking record being password accessible to one or more of said coders, said attending physicians and said patient treatment facility management.

23. The computer controlled method as defined in claim 22 wherein said coder created patient administrative record portion is protected by a HIPAA compliant firewall.

24. The computer controlled method as defined in claim 22 wherein said tracking record is protected by a HIPAA compliant firewall.

25. The computer controlled method as defined in claim 22 wherein said communication link enables the exchange of information between said coder and said attending physician regarding the assignment of an MS-DRG code to said coder created patient administrative record portion.

26. The computer controlled method as defined in claim 22 wherein said coder and said attending physician are provided access to one or more look-up tables when accessing said coder created patient administrative record portion, said one or more look-up tables being selected from a group including patient name, attending physician name and MS-DRG code information.

27. The computer controlled method as defined in claim 22 wherein said patient treatment facility management is able to use said coding information recording function and said coding communication tracking function to provide one or more password accessible reports, said one or more password accessible reports being selected from a group including:
status of an individual coder request to an attending physician for information regarding assignment of an MS-DRG code;
status of an individual coder request to an attending physician for information regarding assignment of an MS-DRG code by patient;
requests for information by coder to an attending physician for information regarding assignment of an MS-DRG code by request for information opening date;
requests for information by coder to an attending physician for information regarding assignment of an MS-DRG code by request for information closing date;
requests for information by coder to an attending physician for information regarding assignment of an MS-DRG code during a predetermined time period;
requests for information to an attending physician for information regarding assignment of an MS-DRG code by coder;
requests for information to an attending physician for information regarding assignment of an MS-DRG code by assigned MS-DRG code;
requests for information to an attending physician for information regarding assignment of an MS-DRG code by status;
requests for information to an attending physician for information regarding assignment of an MS-DRG code by suggested MS-DRG code; and
requests for information to an attending physician for information regarding assignment of an MS-DRG code by attending physician.

28. The computer controlled method as defined in claim 22 wherein said patient treatment facility management is able to use said coding information recording function and said coding communication tracking function to obtain one or more password accessible reports, said one or more password accessible reports being selected from a group including:
average time between the initiation of requests for information regarding assignment of an MS-DRG code by a coder and the supply of the information regarding the assignment of an MS-DRG by attending physicians;
average time between the initiation of a request for information regarding the assignment of an MS-DRG code by a coder to an attending physician and the supply of information regarding the supply of information regarding the assignment of an MS-DRG by an attending physician to the coder; and
information maintained by a patient treatment facility in a permanent record.

29. The computer controlled method as defined in claim 22 wherein said coder is able to use said coding information recording function and said coding communication tracking function to obtain one or more password accessible status reports, said one or more password accessible status reports being selected from a group including:
requests to attending physicians for information regarding the assignment of an MS-DRG code that have not been accessed by said attending physician;
requests to attending physicians for information regarding the assignment of an MS-DRG code that have been accessed by the attending physician but have not been answered by the attending physician; and
requests to attending physicians for information regarding the assignment of an MS-DRG code that have been answered by an attending physician.

30. The computer controlled method as defined in claim 22 wherein said attending physician is able to use said coding information recording function and said coding communication tracking function to obtain one or more password accessible status reports, said password accessible status reports including:
requests from coders for information regarding the assignment of an MS-DRG code that have been sent from a coder which remain unanswered;
requests from coders for information regarding the assignment of an MS-DRG code that have been accessed but remain unanswered; and
requests from coders for information regarding the assignment of an MS-DRG code that have been answered.

31. The computer controlled method as defined in claim 22 wherein said coding information recording function and said coding communication tracking function are used to send reminders of unanswered requests for information regarding the assignment of an MS-DRG code to one or more recipients selected from a group including:
coders;
attending physicians;
patient treatment facility management.

32. A computer controlled method for assigning, recording, and managing MS-DRG coding in a patient treatment facility, said computer controlled method comprising the steps of:
creating a coding information recording function within a software package operable on the computer, sand coding information recording function including:
a coder created patient administrative record portion including patient identification, attending physician identification, MS-DRG coding, and message space;
said coder created record patient administrative record portion being password accessible to said coder, said attending physician a consultant or consulting physician selected by said attending physician and patient treatment facility management;
a communication link between said attending physician and said consultant or consulting physician;
a communication link between said coder and said attending physician for approval/disapproval of an MS-DRG code;
creating a coding communication tracking function including:
a tracking record of the identification and the date/time of those seeking access to said coder created patient record;
said tracking record being password accessible to one or more of said coders, said attending physicians and said patient treatment facility management.

33. The computer controlled method as defined in claim 32 wherein said coder created patient administrative record portion is protected by a HIPAA compliant firewall.

34. The computer controlled method as defined in claim 32 wherein said tracking record is protected by a HIPAA compliant firewall.

35. The computer controlled method as defined in claim 32 wherein said communication link between said attending physician and said consultant or consulting physician enables said attending physician to request assistance regarding responding to a request from a coder for information regarding the assignment of an MS-DRG code to said coder created patient administrative record portion.

36. The computer controlled method as defined in claim 32 wherein said communication link enables the exchange of information between said coder and said attending physician regarding the assignment of an MS-DRG code to said coder created patient administrative record portion.

37. The computer controlled method as defined in claim 32 wherein said coder, said attending physician and said consultant or consulting physician are provided access to one or more look-up tables when accessing said coder created patient administrative record portion, said one or more look-up tables being selected from a group including patient name, attending physician name and MS-DRG codes information.

38. The computer controlled system as defined in claim 32 wherein said patient treatment facility management is able to use said coding information recording function and said coding communication tracking function to provide one or more password accessible reports, said one or more password accessible reports being selected from a group including:
status of an individual coder request to an attending physician for information regarding assignment of an MS-DRG code;
status of an individual coder request to an attending physician for information regarding assignment of an MS-DRG code by patient;
requests for information by coder to an attending physician for information regarding assignment of an MS-DRG code by request for information opening date;
requests for information by coder to an attending physician for information regarding assignment of an MS-DRG code by request for information closing date;
requests for information by coder to an attending physician for information regarding assignment of an MS-DRG code during a predetermined time period;
requests for information to an attending physician for information regarding assignment of an MS-DRG code by coder;
requests for assistance by an attending physician to a consultant or consulting physician to provide information regarding assignment of an MS-DRG code by coder;
requests for information to an attending physician for information regarding assignment of an MS-DRG code by assigned MS-DRG code;
requests for information to an attending physician for information regarding assignment of an MS-DRG code by status;
requests for information to an attending physician for information regarding assignment of an MS-DRG code by suggested MS-DRG code; and
requests for information to an attending physician for information regarding assignment of an MS-DRG code by attending physician.

39. The computer controlled method as defined in claim 32 wherein said patient treatment facility management is able to use said coding information recording function and said coding communication tracking function to obtain one or more password accessible global reports, said one or more password accessible global reports being selected from a group including:
average time between the initiation of requests for information regarding assignment of an MS-DRG code by a coder and the supply of the information regarding the assignment of an MS-DRG code by attending physicians;
average time between the initiation of a request for information regarding the assignment of an MS-DRG code by a coder to an attending physician and the supply of information regarding the assignment of an MS-DRG by an attending physician to the coder;
average time between the initiation of a request for assistance by an attending physician to a consultant or consulting physician and the supply of the requested assistance to the attending physician by the consultant or consulting physician; and
information maintained by a patient treatment facility in a permanent record

40. The computer controlled method as defined in claim 32 wherein said coder is able to use said coding information recording function and said coding communication tracking function to obtain one or more password accessible status reports, said password accessible status reports being selected from a group including:
requests to attending physicians for information regarding the assignment of an MS-DRG code that have not been accessed by said attending physician;
requests to attending physicians for information regarding the assignment of an MS-DRG code that have been accessed by the attending physician but have not been answered by the attending physician;
requests by attending physicians to a consultant or consulting physician for assistance that have not been answered; and
requests to attending physicians for information regarding the assignment of an MS-DRG code that have been answered by an attending physician.

41. The computer controlled method as defined in claim 32 wherein said attending physician is able to use said coding information recording function and said coding communication tracking function to obtain one or more password accessible status reports, said password accessible status reports including:
requests from coders for information regarding the assignment of an MS-DRG code that have been sent from a coder which remain unanswered;
requests from coders for information regarding the assignment of an MS-DRG code that have been accessed but remain unanswered;
requests for assistance to consultants or consulting physicians that have not been answered; and
requests from coders for information regarding the assignment of an MS-DRG code that have been answered.

42. The computer controlled method as defined in claim 32 wherein said coding information recording function and said coding communication tracking function are used to send reminders of unanswered requests for information regarding the assignment of an MS-DRG code to one or more recipients selected from a group including:
coders;
attending physicians;
consultants or consulting physician; and
patient treatment facility management.
